(19) United States
(12) Patent Application Publication
(10) Pub. No.: US 2026/0034855 A1
(43) Pub. Date: Feb. 5, 2026

(54) THERMAL MANAGEMENT SYSTEM FOR VEHICLE AND METHOD OF CONTROLLING THE SAME

(71) Applicants: Hyundai Motor Company, Seoul (KR); Kia Corporation, Seoul (KR)

(72) Inventors: Jae Woong KIM, Hwaseong-si (KR); Dae Ki HONG, Hwaseong-si (KR); Ki Hoon KIM, Hwaseong-si (KR); Jae Kwon LEE, Hwaseong-si (KR); Se Kyu OH, Hwaseong-si (KR)

(73) Assignees: Hyundai Motor Company, Seoul (KR); Kia Corporation, Seoul (KR)

(21) Appl. No.: 19/193,721

(22) Filed: Apr. 29, 2025

(30) Foreign Application Priority Data
Jul. 30, 2024 (KR) 10-2024-0101047

(51) Int. Cl. B60H 1/00; B60H 1/32

(52) U.S. Cl. CPC B60H 1/00885; B60H 1/00278; B60H 1/32011

(57) ABSTRACT

In a thermal management system for a vehicle and a method for controlling the same, the thermal management system and the control method are configured to determine a maximum cooling capacity of a chiller included in a fluid transfer device of the thermal management system, to set an optimal control target enabling the fluid transfer device to execute battery cooling through minimum consumption of electric power while satisfying a maximum cooling capacity range based on the determined maximum cooling capacity, and to control the fluid transfer device based on deriving an optimal control value satisfying the optimal control target.

### CROSS-REFERENCE TO THE RELATED APPLICATION

The present application claims priority to Korean Patent Application No. 10-2024-0101047 filed on Jul. 30, 2024, the entire contents of which is incorporated herein for all purposes by this reference.

### BACKGROUND OF THE PRESENT DISCLOSURE

### Field of the Present Disclosure

The present disclosure relates to a thermal management system for a vehicle, which is configured to perform thermal management of the vehicle based on optimal control through a predictive model.

### Description of Related Art

In pace with recently increased interest in the environment, use of eco-friendly vehicles provided with an electric motor as a driving source is increasing. Such an eco-friendly vehicle is also referred to as an “electrified vehicle”. As an example of such an electrified vehicle, there is a hybrid electric vehicle (HEV) or an electric vehicle (EV).

Such an electrified vehicle includes parts such as a battery, a motor, etc. for driving of the vehicle. Since operation performance of such parts is influenced by temperature, requirements associated with the parts have been further taken into consideration in terms of thermal management, in addition to internal air conditioning.

In the battery, reversible heat generation and irreversible heat generation occur due to internal chemical reaction generated during discharging or recharging of the battery. For the present reason, when heat generation of the battery is not solved, there may be influence on output power and lifespan of the battery. Furthermore, the battery may show degradation of output power and recharging performance at a low temperature. Therefore, for efficient driving of the vehicle, it is necessary to manage a temperature of the battery within an appropriate temperature range to prevent the temperature of the battery from being too low or too high.

The information included in this Background of the present disclosure is only for enhancement of understanding of the general background of the present disclosure and may not be taken as an acknowledgement or any form of suggestion that this information forms the prior art already known to a person skilled in the art.

### BRIEF SUMMARY

Various aspects of the present disclosure are directed to providing a thermal management system for a vehicle, which is configured for efficiently performing thermal management of a battery provided in the vehicle through an optimal control method.

Objects of the present disclosure are not limited to the above-described object, and other objects of the present disclosure not yet described will be more clearly understood by those skilled in the art from the following detailed description.

In accordance with an aspect of the present disclosure, the above and other objects may be accomplished by the provision of a thermal management system for a vehicle including a fluid transfer device including a coolant line configured to allow coolant to circulate therein, a refrigerant line configured to allow refrigerant to circulate therein, and a chiller connected to the coolant line and the refrigerant line to allow heat-exchange between the coolant and the refrigerant to be executed in the chiller, the fluid transfer device being configured to execute cooling of a battery of the vehicle through absorption of heat of the battery through the coolant and dissipation of the absorbed heat to the refrigerant and to consume electric power in execution of the battery cooling, and a controller configured to determine a maximum cooling capacity of the chiller, to set an optimal control target enabling the fluid transfer device to execute the battery cooling through minimum consumption of electric power while satisfying a maximum cooling capacity range based on the determined maximum cooling capacity, and to control the fluid transfer device based on deriving an optimal control value satisfying the optimal control target.

In accordance with another aspect of the present disclosure, there is provided a method for controlling a thermal management system for a vehicle including a fluid transfer device including a coolant line configured to allow coolant to circulate therein, a refrigerant line configured to allow refrigerant to circulate therein, and a chiller connected to the coolant line and the refrigerant line to allow heat-exchange between the coolant and the refrigerant to be executed in the chiller, the fluid transfer device being configured to execute cooling of a battery of the vehicle through absorption of heat of the vehicle battery through the coolant and dissipation of the absorbed heat to the refrigerant and to consume electric power in execution of the battery cooling, the method including determining a maximum cooling capacity of the chiller, setting an optimal control target enabling the fluid transfer device to execute the battery cooling through minimum consumption of electric power while satisfying a maximum cooling capacity range based on the determined maximum cooling capacity, and controlling the fluid transfer device based on deriving an optimal control value satisfying the optimal control target.

In accordance with various embodiments of the present disclosure as described above, it may be possible to reduce a computation amount for control while optimally controlling thermal management of the vehicle, cooling of the battery, taking into consideration a target temperature range and power consumption. Accordingly, it may be possible to easily implement a thermal management system in the vehicle.

The methods and apparatuses of the present disclosure have other features and advantages which will be apparent from or are set forth in more detail in the accompanying drawings, which are incorporated herein, and the following Detailed Description, which together serve to explain certain principles of the present disclosure.

### BRIEF DESCRIPTION OF THE DRAWINGS

FIG. 1 is a diagram showing an example of a configuration of a fluid transfer device applicable to various exemplary embodiments of the present disclosure;

FIG. 2 is a view explaining a battery cooling system of the fluid transfer device according to an exemplary embodiment of the present disclosure;

FIG. 3 is a diagram showing a configuration of a vehicle thermal management system according to an exemplary embodiment of the present disclosure;

FIG. 4 is a diagram explaining optimal control according to an exemplary embodiment of the present disclosure;

FIG. 5 is a diagram explaining a configuration and operation of a controller according to an exemplary embodiment of the present disclosure; and

FIG. 6 is a flowchart explaining a method for controlling the vehicle thermal management system in accordance with an exemplary embodiment of the present disclosure.

It may be understood that the appended drawings are not necessarily to scale, presenting a somewhat simplified representation of various features illustrative of the basic principles of the present disclosure. The specific design features of the present disclosure as included herein, including, for example, specific dimensions, orientations, locations, and shapes will be determined in part by the particularly intended application and use environment.

In the figures, reference numbers refer to the same or equivalent parts of the present disclosure throughout the several figures of the drawing.

### DETAILED DESCRIPTION

Reference will now be made in detail to various embodiments of the present disclosure(s), examples of which are illustrated in the accompanying drawings and described below.

For embodiments of the present disclosure included herein, specific structural or functional descriptions are exemplary to merely describe the exemplary embodiments of the present disclosure, and the exemplary embodiments of the present disclosure may be implemented in various forms and should not be interpreted as being limited to the exemplary embodiments described in the present specification.

As various modifications may be made and diverse embodiments are applicable to the exemplary embodiments according to the concept of the present disclosure, specific embodiments will be illustrated with reference to the accompanying drawings and described in detail herein. However, these specific embodiments should not be construed as limiting the exemplary embodiments according to the concept of the present disclosure, but should be construed as extending to all modifications, equivalents, and substitutes included in the concept and technological scope of the present disclosure.

Unless defined otherwise, terms used herein including technological or scientific terms include the same meaning as generally understood by those of ordinary skill in the art to which the present disclosure pertains. The terms used herein shall be interpreted not only based on the definition of any dictionary but also the meaning which is used in the field to which the present disclosure pertains. Furthermore, unless clearly defined, the terms used herein shall not be interpreted too ideally or formally.

Hereinafter, various exemplary embodiments of the present disclosure will be described in detail with reference to the accompanying drawings, and the same or similar elements are designated by the same reference numerals regardless of the numerals in the drawings and redundant description thereof will be omitted.

In the following description of embodiments, the term “predetermined” means that, when a parameter is used in a process or an algorithm, the numerical value of the parameter has been previously determined. The numerical value of the parameter may be set when the process or the algorithm is begun or during a period in which the process or algorithm is executed in accordance with an exemplary embodiment of the present disclosure.

The suffixes “module” and “unit” of elements herein are used for convenience of description and thus may be used interchangeably and do not have any distinguishable meanings or functions.

In the following description of the exemplary embodiments of the present disclosure, a detailed description of known technologies incorporated herein will be omitted when it may obscure the subject matter of the exemplary embodiments of the present disclosure. Furthermore, the exemplary embodiments of the present disclosure will be more clearly understood from the accompanying drawings and should not be limited by the accompanying drawings, and it is to be appreciated that all changes, equivalents, and substitutes that do not depart from the spirit and technical scope of the present disclosure are encompassed in an exemplary embodiment of the present disclosure.

It will be understood that, although the terms “first”, “second”, etc. may be used herein to describe various elements, these elements should not be limited by these terms. These terms are only used to distinguish one element from another.

In the case where an element is “connected” or “linked” to another element, it should be understood that the element may be directly connected or linked to the other element, or another element may be present therebetween. Conversely, in the case where an element is “directly connected” or “directly linked” to another element, it should be understood that no other element is present therebetween.

Unless clearly used otherwise, singular expressions include a plural meaning.

In the present specification, the term “comprising”, “including”, or the like, is intended to express the existence of the characteristic, the numeral, the step, the operation, the element, the part, or the combination thereof, and does not exclude another characteristic, numeral, step, operation, element, part, or any combination thereof, or any addition thereto.

Furthermore, the term “unit” or “control unit” used in specific terminology such as a motor control unit (MCU), a hybrid control unit (HCU), or the like is only a term widely used for designation of a controller configured for controlling a function of a vehicle, and accordingly, does not mean a generic functional unit.

The controller may include a communication device configured to communicate with another controller or a sensor, for control of a function to be performed accordingly, a memory configured to store an operating system, logic commands, input/output information, etc., and at least one processor configured to execute discrimination, calculation, determination, etc. required for control of the function to be performed.

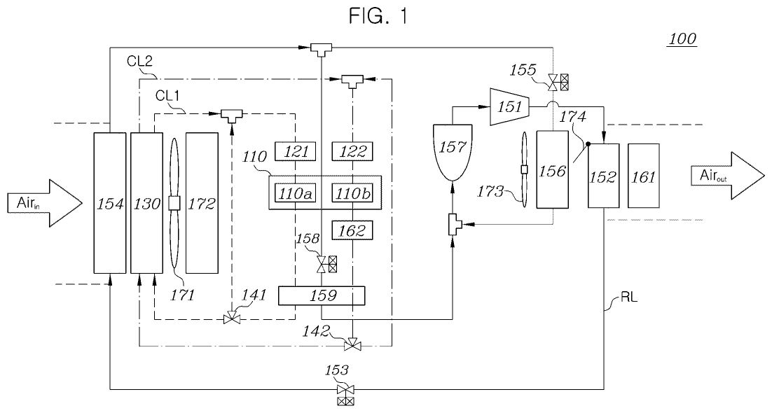

Prior to description of operation of a controller configured for execution of thermal management of a vehicle according to an exemplary embodiment of the present disclosure, illustrative implementation of a fluid transfer device applicable to various exemplary embodiments of the present disclosure will be described with reference to FIG. 1.

FIG. 1 is a diagram showing an example of a configuration of a fluid transfer device applicable to various exemplary embodiments of the present disclosure.

Referring to FIG. 1, a fluid transfer device 100, which is applicable to various exemplary embodiments of the present disclosure, may perform vehicle thermal management such as cooling or heating of at least one vehicle part 110, air conditioning of a vehicle interior (a cabin), etc.

For the present function, the fluid transfer device 100 may not only include coolant lines CL1 and CL2 configured to exchange heat with the vehicle part 100, but also may include a refrigerant line RL configured to exchange heat with coolant and ambient air.

In more detail, a plurality of coolant lines CL1 and CL2 may be provided at the fluid transfer device 100, and the coolant lines CL1 and CL2 may individually exchange heat with different vehicle parts 110, respectively, for heat management of the vehicle parts 110.

Here, the vehicle parts 110 may include a driving system 110a such as a motor, an inverter, etc., and a battery 110b. Of course, in embodiments of the present disclosure, the vehicle parts 110 are not limited to the above-described conditions, and may include various portions requiring dissipation of heat generated therefrom. For example, the vehicle parts 110 may include various types of controllers such as an autonomous-driving controller, a motor controller, a vehicle control, a controller associated with execution of integrated thermal management according to an exemplary embodiment of the present disclosure, etc.

Although the coolant line CL1 for thermal management of the driving system 110a and the coolant line CL2 for thermal management of the battery 110b are shown in FIG. 1, the coolant lines CL1 and CL2 as described above may be substituted by coolant lines for thermal management of other vehicle parts 110 such as a controller, etc. or may coexist with the coolant lines for thermal management of the other vehicle parts 110. Furthermore, in illustrative implementation of the fluid transfer device 100, various cases including the case in which only a single coolant line for thermal management of only one vehicle part 110 is provided, and the case in which a plurality of vehicle parts 110 is connected in series to one coolant line, etc. may be included.

Pumps 121 and 122 may be provided at respective coolant lines CL1 and CL2, for circulation of coolant. The pumps 121 and 122 may feed the coolant to the side of the vehicle part 110, through consumption of electric power. For example, each of the pumps 121 and 122 as described above may be implemented by an electric water pump (EWP) configured to circulate coolant by driving a motor through electrical energy.

The coolant introduced to the side of the vehicle part 110 through the pumps 121 and 122 may absorb heat generated from the vehicle part 110 through heat-exchange with the vehicle part 110 while passing through the vehicle part 110. Accordingly, cooling of the vehicle part 110 may be achieved.

The coolant emerging from the vehicle part 110 may flow to the side of a radiator 130. The coolant may dissipate heat absorbed from the vehicle part 110 through heat-exchange with the radiator 130 while passing through the radiator 130, and may again be introduced to the side of the vehicle part 110.

In the instant case, the radiator 130 may be provided at each of the coolant lines CL1 and CL2 in an individual manner. In the instant case, radiators 130 respectively corresponding to the coolant lines CL1 and CL2 may be classified into, for example, a high-temperature radiator and a low-temperature radiator, respectively.

A compressor 151, a plurality of condensers 152 and 154, a plurality of expanders 153, 155, and 158, an evaporator 156, an accumulator 157, and a chiller 159 may be provided at the refrigerant line RL. The fluid transfer device 100 may perform a heat pump function through the above-described constituent elements.

In the instant case, the compressor 151 may discharge refrigerant in a high-temperature and high-pressure state through consumption of electric power, for implementation of the heat pump function through circulation of the refrigerant. The refrigerant emerging from the compressor 151 repeat heat dissipation and heat absorption while passing through an indoor condenser, that is, the condenser 152, the expander 153, an outdoor condenser, that is, the condenser 154, the expander 155, the evaporator 156, and the accumulator 157.

The refrigerant line RL may pass through portions of the coolant lines CL1 and CL2 to collect waste heat of the vehicle part 110 from the coolant lines CL1 and CL2. In the instant case, the refrigerant line RL may exchange heat with the coolant lines CL1 and CL2 through the chiller 159 connected to the coolant lines CL1 and CL2. Meanwhile, the fluid transfer device 100 may include a plurality of chillers 159, differently from the case shown in FIG. 1, and the plurality of chillers 159 may be connected to corresponding ones of the coolant lines CL1 and CL2, respectively.

Meanwhile, for execution of vehicle thermal management for different purposes, the fluid transfer device 100 may form various heat transfer paths through the coolant lines CL1 and CL2.

For example, the coolant line CL1 for thermal management of the driving system 110a may form a heat transfer path configured to outwardly dissipate heat absorbed from the driving system 110a through the radiator 130, and a heat transfer path configured to transfer the heat absorbed from the driving system 110a to the refrigerant line RL through the chiller 159. The coolant line CL1 may simultaneously form the above-described heat transfer paths.

The above-described heat transfer paths may be varied in accordance with a flow direction of the coolant, and the flow direction of the coolant may be adjusted by a valve 141 or the like provided at the coolant line CL1. Furthermore, circulation of the coolant may be suppressed through stop of operation of the pump 121 to prevent heat generated from the driving system 110a from being dissipated through the radiator 130 or the chiller 159.

In another example, the coolant line CL2 for thermal management of the battery 110b may form a heat transfer path configured to outwardly dissipate heat absorbed from the battery 110b through the radiator 130, and a heat transfer path configured not to pass through the radiator 130. In the heat transfer path configured not to pass through the radiator 130, heat generated from the battery 110b may be transferred to the refrigerant line RL through the chiller 159 in accordance with circulation of the refrigerant in the refrigerant line RL, and, accordingly, the battery 110b may be cooled. Otherwise, in place of transfer of heat to the refrigerant line RL, heat of the coolant heated through a heater 162 configured to heat the coolant may be transferred to the battery 110b in the heat transfer path configured not to pass through the radiator 130, and, accordingly, the battery 110b may be heated. The above-described heat transfer paths may be varied in accordance with a flow direction of the coolant, and the flow direction of the coolant may be adjusted by a valve 142 or the like provided at the coolant line CL2.

The fluid transfer device 100 may collect heat generated from the vehicle part 110, that is, waste heat, through the heat transfer path configured to transfer heat absorbed from the vehicle part 110 to the refrigerant line RL through the chiller 159, among the above-described heat transfer paths, to re-use the collected heat for thermal management of a vehicle interior. Accordingly, energy efficiency of vehicle thermal management may be enhanced.

Meanwhile, the fluid transfer device 100 may also exchange heat with ambient air, and may use heat absorbed from the ambient air through heat-exchange, for thermal management. In more detail, heat-exchange with the ambient air may not only be indirectly performed through the radiator 130, but also may be performed through an outdoor evaporator configured to absorb heat from the ambient air.

During execution of thermal management as described above, the fluid transfer device 100 may adjust flow of air from the exterior to the interior thereof. For adjustment of air flow, the fluid transfer device 100 may include a blowing device, an opening/closing device, etc.

The blowing device may include, for example, a cooling fan 171 configured to adjust introduction of ambient air, and a blower 173 configured to adjust discharge of air into the vehicle interior. The opening/closing device may include, for example, an air flap 172 configured to adjust introduction of ambient air, and a temperature door 174 configured to adjust discharge of air into the vehicle interior. Electric power may be consumed for execution of operation of the blowing device and the opening/closing device.

Furthermore, the fluid transfer device 100 may include an electric heating device configured to increase a temperature of air or coolant. The electric heating device may include a heater 161 configured to heat air discharged into the vehicle interior. In the instant case, the heater 161 may be implemented by, for example, a positive temperature coefficient (PTC) heater. Furthermore, the electric heating device may include the heater 162 which is configured to heat coolant for an increase in temperature of the battery 110b, as described above.

In accordance with the above-described configuration of the fluid transfer device 100, thermal management of the vehicle may be conducted in various manners. Various thermal management scenarios may be derived in accordance with an internal state of the vehicle, an external state of the vehicle, states of the vehicle parts 110a and 110b, etc.

Meanwhile, FIG. 1 mainly shows constituent elements associated with description of the fluid transfer device 100 applicable to various exemplary embodiments of the present disclosure, and the fluid transfer device 100 may be practically implemented through inclusion of a greater or smaller number of constituent elements than that of the shown constituent elements.

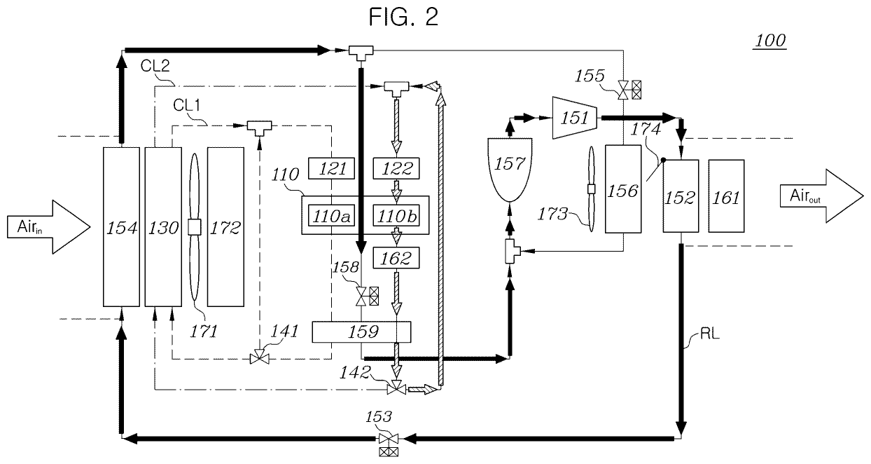

Furthermore, the fluid transfer device 100 described with reference to FIG. 1 illustrates an implementation thereof applicable to various exemplary embodiments of the present disclosure, and accordingly, fluid transfer devices according to various exemplary embodiments of the present disclosure are not limited to the above-described fluid transfer device 100. Hereinafter, a system for performing battery cooling through the fluid transfer device 100 will be described with reference to FIG. 2.

FIG. 2 is a view explaining a battery cooling system of the fluid transfer device according to an exemplary embodiment of the present disclosure.

Referring to FIG. 2, battery cooling executed by the fluid transfer device 100 of FIG. 1 is shown. In an exemplary embodiment of the present disclosure, cooling of the battery 110b may be performed through the coolant line CL2, the refrigerant line RL, and the chiller 159.

In detail, the battery 110b may dissipate heat generated during operation thereof in accordance with heat-exchange with coolant introduced to the side of the battery 110b. That is, heat generated from the battery 110b may be absorbed by coolant circulating in the coolant line CL2.

The chiller 159 may be disposed at the coolant line CL2 at a downstream end portion of the battery 110b in a flow direction of the coolant, and the coolant line CL2 and the refrigerant line RL may be connected to the chiller 159. In the instant case, heat-exchange between the coolant and the refrigerant is conducted in the chiller 159. As a result, heat generated from the battery 110b is absorbed in the refrigerant via the coolant.

The refrigerant absorbing heat of the battery 110b through heat-exchange with the coolant dissipates the absorbed heat while passing through the accumulator 157, the compressor 151, the condensers 152 and 154, the expanders 153, 155, and 158, etc. in accordance with circulation thereof in the refrigerant line RL, and returns to the chiller 159, and accordingly, may again exchange heat with the coolant.

The above-described procedure may be repeated. Through repetition of the procedure, cooling of the battery 110b may be performed. Of course, the present disclosure is not limited to battery cooling through the fluid transfer device 100 according to the above-described embodiment. Furthermore, a system configured to cool the battery 110b using ambient air, in place of refrigerant, may be employed.

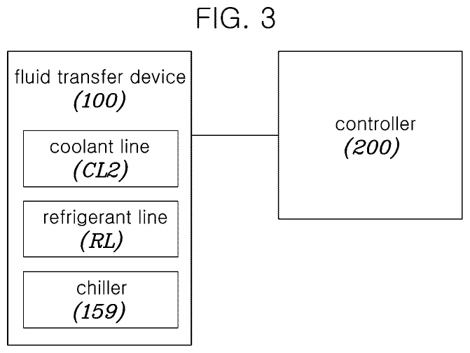

Hereinafter, a configuration of the vehicle thermal management system will be described with reference to FIG. 3 in conjunction with illustration of the above-described fluid transfer device 100 and cooling of the battery 110b therethrough.

FIG. 3 is a diagram showing a configuration of the vehicle thermal management system according to an exemplary embodiment of the present disclosure.

Referring to FIG. 3, the vehicle thermal management system according to the exemplary embodiment of the present disclosure may include a fluid transfer device 100, which includes a coolant line CL2, a refrigerant line RL, and a chiller 159, and a controller 200 configured to control the fluid transfer device 100. Of course, FIG. 3 mainly shows constituent elements associated with the description of an exemplary embodiment of the present disclosure, and the vehicle thermal management system may be practically implemented through inclusion of a greater or smaller number of constituent elements than that of the shown constituent elements.

Since the fluid transfer device 100 has been described through illustration of FIG. 1 and FIG. 2, the following description will be provided mainly in conjunction with the controller 200.

First, the controller 200 may be configured to determine a maximum cooling capacity of the chiller 159, may set an optimal control target enabling the fluid transfer device 100 to perform battery cooling through minimum consumption of electric power while satisfying the determined maximum cooling capacity in a heat-exchange procedure through the chiller 159, and may be configured for controlling the fluid transfer device 100 based on deriving an optimal control value satisfying the optimal control target.

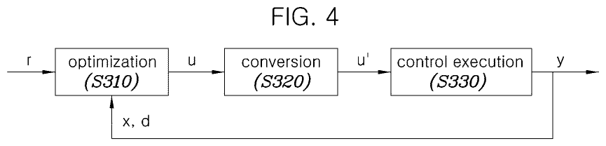

The controller 200 may use a control model according to a predictive state value based on a current state value in determining the maximum cooling capacity, setting the optimal control target, and controlling the fluid transfer device 100 based on the optimal control value, as described above. This will be described with reference to FIG. 4.

FIG. 4 is a diagram explaining optimal control according to an exemplary embodiment of the present disclosure.

Referring to FIG. 4, in accordance with an exemplary embodiment of the present disclosure, the controller 200 may perform vehicle thermal management through procedures of optimization S310, conversion S320, and control execution S330.

First, the optimization procedure S310 may be executed on a model basis. For example, proportional-integral-derivative (PID) control, linear-quadratic regulator (LQR) control, etc. may be used for optimization. In in accordance with an exemplary embodiment of the present disclosure, the optimization procedure S310 may be executed through model-based predictive control.

In more detail, the optimization procedure S310 through the model-based predictive control may be executed in a direction decreasing a future error in basically deriving an optimal control value u enabling an output value y to trace a target value r.

The optimal control value u may be determined using a control model for a predictive state value according to a current state value x. That is, the optimal control value u may be determined taking into consideration not only a current state, but also a predictive future state.

At least one of a current control value u or a disturbance d as well as the current state value x may be further reflected in the control model for the predictive state value. For example, this may be expressed by the following expression.

$${x}_{k + 1} = {A}_{k} {x}_{k} + {B}_{k} {u}_{k} + {B}_{w , k} {w}_{k} + {B}_{∅ , k}$$

In the present expression, x_{□} and xₖ₊₁ represent the current state value and the predictive state value, respectively, and w_{□} represents the disturbance. A_{□}, B_{□}, and B_{w,k} represent influence of the current state, a control input, and the disturbance on the future state, respectively. B_{ø,k} is an item for reflecting uncertainty of prediction. The k is a natural number.

It may be possible to reflect a predicted future state in derivation of an optimal control value by use of the control model for the predictive state value.

Meanwhile, in the optimization procedure S310, optimization of the target value r may also be executed before derivation of the optimal control value u. In the instant case, optimization of the target value r may be executed in a normal state, i.e., a steady-state condition, and a control model for an output value may be used in optimization of the target value r. In the instant case, the control module for the output value represents the current state value and an output value according to the current control value. For example, the present control model may be expressed by the following expression.

$$[ \begin{matrix}{A}_{k} - I & {B}_{k} \\ {C}_{k} & 0\end{matrix} ] [ \begin{matrix}{x}_{ss} \\ {u}_{ss}\end{matrix} ] = [ \begin{matrix}- ( {B}_{w , k} {w}_{k} r + {B}_{∅ , k} ) \\ r\end{matrix} ]$$

In the present expression, x_{□□} and u_{□□} represent a state value and a control value in a normal state, respectively, and w_{□} represents a disturbance. A_{□}, B_{□}, and B_{w,k} represent influence of a current state, a control input, and the disturbance on a future state, respectively, and C_{□} represents influence of a state value on an output value. r may represent a target value, that is, an output value as a target of control. B_{ø,k} is an item for reflecting uncertainty of prediction.

Differently from the above-described case, the optimization procedure for the target value r in the normal state may be omitted in an exemplary embodiment of the present disclosure. In the instant case, optimization may be executed in a dynamic state in which there is a variation in state value so that an output value traces a target value.

Meanwhile, in the optimization procedure S310 through the model-based predictive control, the optimal control value u may be determined through a cost function for a predetermined predictive range.

Here, the predetermined predictive range represents how far ahead the future is predicted, and may be expressed by a prediction horizon. When the predictive range increases, performance of optimization may be enhanced. Of course, computational load of the controller 200 for prediction may be increased, corresponding to the increased prediction range.

In an exemplary embodiment of the present disclosure, the optimal control value may be determined as a control value enabling a cost function for the predetermined predictive range to be minimized. The control value may be optimized in a dynamic state in which the state value x is varied. That is, the optimal control value u may be determined in the dynamic state. In the instant case, both the target value r and the optimal control value u may be optimized in the dynamic state (that is, one stage), or the target value r may be optimized in the normal state, and the optimal control value u may be optimized in the dynamic state (that is, two stages).

The optimal control value u determined as described above may be a physical quantity influencing vehicle thermal management in accordance with operation of each constituent element of the fluid transfer device 100, for example, a flow rate of refrigerant, a flow rate of coolant, a flow rate of air, or the like. In the instant case, through the conversion procedure S320, the controller 200 may convert the optimal control value u determined in a form of a physical quantity into an operation quantity u′ for controlling operation of each constituent element of the fluid transfer device 100, for example, a rotation speed, a duty, or the like. Of course, the optimal control value u is not limited to the above-described condition, and may take various forms in accordance with each constituent element of the fluid transfer device 100. In the instant case, the conversion procedure S320 may be omitted when conversion into an operation quantity is unnecessary.

After execution of the optimization procedure S310 and the conversion procedure S320 as described above, substantial control for constituent elements of the fluid transfer device 100 is executed in accordance with the optimal control value u and the operation quantity u′ based thereon, and results of execution of the control may be represented in a form of an output value y. In the instant case, the output value y may be collected through various sensors provided in the vehicle, and may be again transferred to the controller 200 after being converted into a physical quantity, if necessary. In the instant case, the controller 200 may be configured to determine a current state x and a disturbance d in accordance with the output value y, and may be again reflected in the optimization procedure S310.

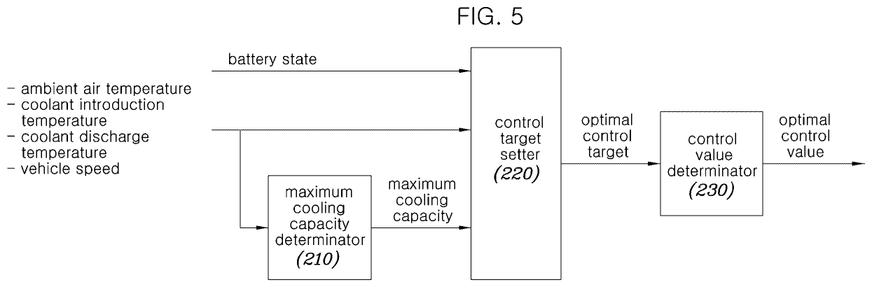

Hereinafter, a method of executing battery cooling through the above-described optimal control in accordance with an exemplary embodiment will be described with reference to FIG. 5.

FIG. 5 is a diagram explaining a configuration and operation of the controller according to an exemplary embodiment of the present disclosure.

Referring to FIG. 5, the controller 200 may include a maximum cooling capacity determinator 210, a control target setter 220, and a control value determinator 230.

Herein, in an exemplary embodiment of the present disclosure, the maximum cooling capacity determinator 210, the control target setter 220, and the control value determinator 230 may be implemented as separate processors or as a single integrated processor.

First, the maximum cooling capacity determinator 210 may receive a temperature of ambient air, an introduction temperature of coolant, a discharge temperature of coolant, a vehicle speed, etc., through sensors and may be configured to determine a maximum cooling capacity based on a first cost function reflecting, therein, a mass flow rate of coolant circulating in the coolant line CL2 and a temperature of coolant introduced to the side battery 110b. The first cost function may be expressed by the following expression.

$${\dot{Q}}_{max} = min ( - {\dot{m}}_{c} {c}_{p , c} ( {T}_{ci} - {T}_{co} ) )$$

In the present expression, \dot{Q}_{□□□} represents a maximum cooling capacity and means a maximum heat absorption amount for the battery 110b in the chiller 159, \dot{m}_{□} represents a flow rate of coolant circulating in the coolant line CL2 (mass flow rate), c_{p,c} represents specific heat of coolant, T_{□□} represents an introduction temperature of coolant introduced to the side of the battery 110b, and T_{□□} represents a discharge temperature of coolant emerging from the battery 110b. Among these factors, the mass flow rate \dot{m}_{□} of coolant and the introduction temperature T_{□□} of coolant are controllable factors, and, accordingly, the maximum cooling capacity may be varied in accordance with the mass flow rate \dot{m}_{□} of coolant and the introduction temperature T_{□□} of coolant.

Meanwhile, upon determining the maximum cooling capacity, the maximum cooling capacity determinator 210 may be configured to determine the maximum cooling capacity under constraints for a predetermined flow rate range in association with a flow rate of coolant. In the instant case, the constraints for the flow rate range may be satisfied when the flow rate of coolant is included in the flow rate range, and may be set in accordance with a configuration and the specifications of the fluid transfer device 100.

When the maximum cooling capacity has been determined, the control target setter 220 receives the maximum cooling capacity together with the temperature of ambient air, the introduction temperature of coolant, the discharge temperature of coolant, the vehicle speed, a battery state (a voltage, a current, a charged amount, etc. of the battery), etc., may set an optimal control target based on a second cost function reflecting, therein, costs of electric power consumed by the coolant pump 122 and costs of a cooling capacity throughout a predetermined predictive range under constraints for the determined maximum cooling capacity. In the instant case, the second cost function may be expressed by, for example, the following expression.

$${U}_{ref} = min {\sum }_{k = 0}^{N - 1} {P}_{ewp} ( k ) + {w}_{c} \dot{Q} ( k )$$

In the present expression, U_{□□□} represents an optimal control target, P_{□□□}(k) represents consumed electric power of the coolant pump 122, \dot{Q}(k) represents a cooling capacity, and w_{□} represents a weight of a cooling capacity with respect to consumed electric power. The optimal control target may be set so that the sum of values determined in a predictive range from k=1 to k=N−1 is minimized. The N is a natural number.

In the instant case, in the optimal control target, the flow rate of coolant circulating in the coolant line CL2 and the introduction temperature of coolant introduced to the side of the battery 110b may be included. Furthermore, the control target setter 220 may set the optimal control target, taking into consideration constraints for the target temperature range predetermined for the temperature of the battery 110b. In the instant case, the constraints for the target temperature range may be satisfied when the temperature of the battery 110b is included in the target temperature range. The target temperature range may be determined based on a state of the battery 110b (a voltage, a current, a charged amount, etc. of the battery), and may be varied in accordance with a kind or a specification of the battery 110b, etc.

That is, in an exemplary embodiment of the present disclosure, the optimal control target may be understood as a flow rate of coolant and an introduction temperature of coolant enabling minimum consumption of electric power in a procedure of cooling the battery 110b through the chiller 159 while satisfying a target temperature range for thermal management of the battery 110b.

Meanwhile, the optimal control target set as described above is input to the control value determinator 230. The control value determinator 230 is configured to determine an optimal control value which is a control value enabling the fluid transfer device 10 to perform battery cooling through minimum consumption of electric power while satisfying the set optimal control target.

In the instant case, the control value determinator 230 may determine the optimal control value based on a third cost function reflecting, therein, costs of power consumption of the coolant pump 122, power consumption of the compressor 151, power consumption of the fan 171, and a variation in control value throughout a predetermined predictive range. In the instant case, the third cost function may be expressed by, for example, the following expression.

$${u}_{opt} = min ( {P}_{comp} + {P}_{fan} + {P}_{ewp} + {w}_{rate} Δ {u}^{2} )$$

In the present expression, u_{□□□} represents an optimal control value, P_{□□□□} represents consumed electric power of the compressor 151, P_{□□□} represents consumed electric power of the fan 171, P_{□□□} represents consumed electric power of the coolant pump 122, and w_{□□□□} Δu² represents costs of a variation in control value. w_{□□□□} represents a weight of a variation in control value with respect to consumed electric power.

In the instant case, in the optimal control value, a flow rate of refrigerant discharged through the compressor 151, a flow rate of air introduced through the fan 171, and a flow rate of coolant passing through the coolant pump 122 may be included. Here, each flow rate may mean a mass flow rate.

When a maximum cooling capacity is first determined, an optimal control target is then set based on the determined maximum cooling capacity, and an optimal control value is finally determined based on the optimal control target, as described above, the computation amount required for each optimal control is reduced, and, accordingly, the computational load of the controller implemented as the controller 200 may be reduced.

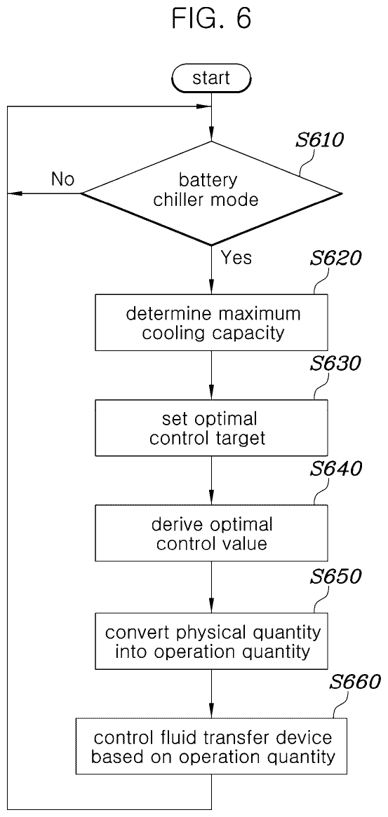

Hereinafter, the above-described thermal management procedure will be described through a flowchart with reference to FIG. 6.

FIG. 6 is a flowchart explaining a method for controlling the vehicle thermal management system in accordance with an exemplary embodiment of the present disclosure.

Referring to FIG. 6, the controller 200 may first determine whether or not the fluid transfer device 100 is operating in a battery chiller mode (S610). Here, the battery chiller mode means a mode in which cooling of the battery 110b is executed through coolant, refrigerant, and a chiller, and corresponds to the cooling method described with reference to FIG. 2.

When the fluid transfer device 100 is operating in the battery chiller mode (“Yes” in S610), the controller 200 is first configured to determine a maximum cooling capacity of the chiller 159 before deriving an optimal control value (S620). In the instant case, a first cost function reflecting, therein, a flow rate of coolant circulating in a coolant line and an introduction temperature of coolant introduced to the side of the battery may be used.

Thereafter, the controller 200 sets an optimal control target based on the maximum cooling capacity (S630). In the instant case, a second cost function reflecting, therein, costs of electric power consumed by the fluid transfer device 100 and costs of a cooling capacity of the fluid transfer device 100 throughout a predetermined predictive range under constraints for the determined maximum cooling capacity may be used.

When the optimal control target has been set, as described above, the controller 200 determines an optimal control value satisfying the optimal control target (S640). In the instant case, a third cost function reflecting, therein, consumed electric power of the fluid transfer device 100 throughout the predetermined predictive range may be used.

The controller 200 converts the optimal control value, which is determined in a form of physical quantities such as a flow rate of coolant, a flow rate of refrigerant, and a flow rate of air, into operation quantities, (S650) and is configured to control constituent elements, to be controlled, included in the fluid transfer device 100, such as the compressor 151, the coolant pump 122, the pan 171, etc., based on the converted operation quantities (S660).

As apparent from the above description, in accordance with various embodiments of the present disclosure as described above, it may be possible to reduce a computation amount for control while optimally controlling thermal management of the vehicle, cooling of the battery, taking into consideration a target temperature range and power consumption, and accordingly, to easily implement a thermal management system in the vehicle.

Furthermore, the term related to a control device such as “controller”, “control apparatus”, “control unit”, “control device”, “control module”, “control circuit”, or “server”, etc refers to a hardware device including a memory and a processor configured to execute one or more steps interpreted as an algorithm structure. The memory stores algorithm steps, and the processor executes the algorithm steps to perform one or more processes of a method in accordance with various exemplary embodiments of the present disclosure. The control device according to exemplary embodiments of the present disclosure may be implemented through a nonvolatile memory configured to store algorithms for controlling operation of various components of a vehicle or data about software commands for executing the algorithms, and a processor configured to perform operation to be described above using the data stored in the memory. The memory and the processor may be individual chips. Alternatively, the memory and the processor may be integrated in a single chip. The processor may be implemented as one or more processors. The processor may include various logic circuits and operation circuits, may be configured for processing data according to a program provided from the memory, and may be configured to generate a control signal according to the processing result.

The control device may be at least one microprocessor operated by a predetermined program which may include a series of commands for carrying out the method included in the aforementioned various exemplary embodiments of the present disclosure.

The aforementioned invention can also be embodied as computer readable codes on a computer readable recording medium. The computer readable recording medium is any data storage device that can store data which may be thereafter read by a computer system and store and execute program instructions which may be thereafter read by a computer system. Examples of the computer readable recording medium include Hard Disk Drive (HDD), solid state disk (SSD), Silicon Disk Drive (SDD), read-only memory (ROM), random-access memory (RAM), CD-ROMs, magnetic tapes, floppy discs, optical data storage devices, etc and implementation as carrier waves (e.g., transmission over the Internet). Examples of the program instruction include machine language code such as those generated by a compiler, as well as high-level language code which may be executed by a computer using an interpreter or the like. Furthermore, the non-transitory computer-readable recording medium may be distributed over computer systems connected through a network, and computer-readable program code may be stored and executed in a distributive manner.

In various exemplary embodiments of the present disclosure, each operation described above may be performed by a control device, and the control device may be configured by a plurality of control devices, or an integrated single control device.

In various exemplary embodiments of the present disclosure, the memory and the processor may be provided as one chip, or provided as separate chips.

In various exemplary embodiments of the present disclosure, the scope of the present disclosure includes software or machine-executable commands (e.g., an operating system, an application, firmware, a program, etc.) for enabling operations according to the methods of various embodiments to be executed on an apparatus or a computer, a non-transitory computer-readable medium including such software or commands stored thereon and executable on the apparatus or the computer.

In various exemplary embodiments of the present disclosure, the control device may be implemented in a form of hardware or software, or may be implemented in a combination of hardware and software.

Software implementations may include software components (or elements), object-oriented software components, class components, task components, processes, functions, attributes, procedures, subroutines, program code segments, drivers, firmware, microcode, data, database, data structures, tables, arrays, and variables. The software, data, and the like may be stored in memory and executed by a processor. The memory or processor may employ a variety of means well-known to a person including ordinary knowledge in the art.

Furthermore, the terms such as “unit”, “module”, etc. included in the specification mean units for processing at least one function or operation, which may be implemented by hardware, software, or a combination thereof.

In the flowchart described with reference to the drawings, the flowchart may be performed by the controller or the processor. The order of operations in the flowchart may be changed, a plurality of operations may be merged, or any operation may be divided, and a specific operation may not be performed. Furthermore, the operations in the flowchart may be performed sequentially, but not necessarily performed sequentially. For example, the order of the operations may be changed, and at least two operations may be performed in parallel.

Hereinafter, the fact that pieces of hardware are coupled operatively may include the fact that a direct and/or indirect connection between the pieces of hardware is established by wired and/or wirelessly.

In an exemplary embodiment of the present disclosure, the vehicle may be referred to as being based on a concept including various means of transportation. In some cases, the vehicle may be interpreted as being based on a concept including not only various means of land transportation, such as cars, motorcycles, trucks, and buses, that drive on roads but also various means of transportation such as airplanes, drones, ships, etc.

For convenience in explanation and accurate definition in the appended claims, the terms “upper”, “lower”, “inner”, “outer”, “up”, “down”, “upwards”, “downwards”, “front”, “rear”, “back”, “inside”, “outside”, “inwardly”, “outwardly”, “interior”, “exterior”, “internal”, “external”, “forwards”, and “backwards” are used to describe features of the exemplary embodiments with reference to the positions of such features as displayed in the figures. It will be further understood that the term “connect” or its derivatives refer both to direct and indirect connection.

The term “and/or” may include a combination of a plurality of related listed items or any of a plurality of related listed items. For example, “A and/or B” includes all three cases such as “A”, “B”, and “A and B”.

In exemplary embodiments of the present disclosure, “at least one of A and B” may refer to “at least one of A or B” or “at least one of combinations of at least one of A and B”. Furthermore, “one or more of A and B” may refer to “one or more of A or B” or “one or more of combinations of one or more of A and B”.

In the present specification, unless stated otherwise, a singular expression includes a plural expression unless the context clearly indicates otherwise.

In the exemplary embodiment of the present disclosure, it should be understood that a term such as “include” or “have” is directed to designate that the features, numbers, steps, operations, elements, parts, or combinations thereof described in the specification are present, and does not preclude the possibility of addition or presence of one or more other features, numbers, steps, operations, elements, parts, or combinations thereof.

According to an exemplary embodiment of the present disclosure, components may be combined with each other to be implemented as one, or some components may be omitted.

The foregoing descriptions of specific exemplary embodiments of the present disclosure have been presented for purposes of illustration and description. They are not intended to be exhaustive or to limit the present disclosure to the precise forms disclosed, and obviously many modifications and variations are possible in light of the above teachings. The exemplary embodiments were chosen and described in order to explain certain principles of the invention and their practical application, to enable others skilled in the art to make and utilize various exemplary embodiments of the present disclosure, as well as various alternatives and modifications thereof. It is intended that the scope of the present disclosure be defined by the Claims appended hereto and their equivalents.

What is claimed is:

1. A thermal management system for a vehicle, the system comprising:
a fluid transfer device including a coolant line allowing coolant to circulate in the coolant line, a refrigerant line allowing refrigerant to circulate in the refrigerant line, and a chiller connected to the coolant line and the refrigerant line to allow heat-exchange between the coolant and the refrigerant to be executed in the chiller, wherein the fluid transfer device executes cooling of a battery of the vehicle through absorption of heat of the battery through the coolant and dissipation of the absorbed heat to the refrigerant and consumes electric power in cooling of the battery; and
a controller configured to determine a maximum cooling capacity of the chiller, to set an optimal control target enabling the fluid transfer device to execute the cooling of the battery through minimum consumption of the electric power while satisfying a maximum cooling capacity range based on the determined maximum cooling capacity, and to control the fluid transfer device based on deriving an optimal control value satisfying the optimal control target.

2. The thermal management system of claim 1, wherein the controller is further configured to utilize a control model for a predictive state value according to a current state value in association with the determination of the maximum cooling capacity, the setting of the optimal control target, and the derivation of the optimal control value.

3. The thermal management system of claim 2, wherein the controller is further configured to determine the maximum cooling capacity based on a first cost function reflecting a flow rate of the coolant circulating in the coolant line and an introduction temperature of the coolant introduced to the battery.

4. The thermal management system of claim 3, wherein the controller is further configured to determine the maximum cooling capacity under constraints for a predetermined flow rate range for the flow rate of the coolant.

5. The thermal management system of claim 2,
wherein the fluid transfer device includes a coolant pump,
wherein the fluid transfer device consumes the electric power through the coolant pump disposed at the coolant line and circulating the coolant through consumption of the electric power, and
wherein the controller is further configured to set the optimal control target based on a second cost function reflecting costs of the electric power consumed by the fluid transfer device and costs of a cooling capacity throughout a predetermined predictive range under constraints for the determined maximum cooling capacity.

6. The thermal management system of claim 5, wherein the controller is further configured to set the optimal control target, further considering constraints for a predetermined target temperature range for a temperature of the battery.

7. The thermal management system of claim 5, wherein the optimal control target includes a flow rate of the coolant circulating in the coolant line and an introduction temperature of the coolant introduced to the battery.

8. The thermal management system of claim 2, wherein the optimal control value is a control value enabling the fluid transfer device to execute the cooling of the battery through the minimum consumption of the electric power while satisfying the optimal control target.

9. The thermal management system of claim 8,
wherein the fluid transfer device includes a coolant pump, a compressor and a fan,
wherein the fluid transfer device consumes the electric power through at least one of the coolant pump disposed at the coolant line and circulating the coolant, the compressor compressing the refrigerant and discharging the compressed refrigerant, or the fan introducing ambient air around the vehicle in the fluid transfer device, and
wherein the optimal control value is determined based on a third cost function reflecting consumed electric power of the fluid transfer device throughout a predetermined predictive range.

10. The thermal management system of claim 9, wherein the optimal control value includes at least one of a flow rate of the coolant passing through the coolant pump, a flow rate of the refrigerant discharged through the compressor, or a flow rate of the air introduced through the fan.

11. A method for controlling a thermal management system for a vehicle including a fluid transfer device including a coolant line allowing coolant to circulate in the coolant line, a refrigerant line allowing refrigerant to circulate in the refrigerant line, and a chiller connected to the coolant line and the refrigerant line to allow heat-exchange between the coolant and the refrigerant to be executed in the chiller, wherein the fluid transfer device executes cooling of a battery of the vehicle through absorption of heat of the vehicle battery through the coolant and dissipation of the absorbed heat to the refrigerant and consumes electric power in cooling of the battery, the method comprising:
determining, by a processor, a maximum cooling capacity of the chiller;
setting, by the processor, an optimal control target enabling the fluid transfer device to execute the cooling of the battery the electric power through minimum consumption of the electric power while satisfying a maximum cooling capacity range based on the determined maximum cooling capacity; and
controlling, by the processor, the fluid transfer device based on deriving an optimal control value satisfying the optimal control target.

12. The method of claim 11, wherein the determining of the maximum cooling capacity, the setting of the optimal control target, and the controlling of the fluid transfer device based on the optimal control value are executed using a control model for a predictive state value according to a current state value.

13. The method of claim 12, wherein the determining of the maximum cooling capacity includes determining the maximum cooling capacity based on a first cost function reflecting a flow rate of the coolant circulating in the coolant line and an introduction temperature of the coolant introduced to the battery.

14. The method of claim 13, wherein the determining of the maximum cooling capacity determines the maximum cooling capacity under constraints for a predetermined flow rate range for the flow rate of the coolant.

15. The method of claim 12,
wherein the fluid transfer device includes a coolant pump,
wherein the fluid transfer device consumes the electric power through the coolant pump disposed at the coolant line and circulating the coolant through consumption of the electric power, and
wherein the setting of the optimal control target includes setting the optimal control target based on a second cost function reflecting costs of the electric power consumed by the fluid transfer device and costs of a cooling capacity throughout a predetermined predictive range under constraints for the determined maximum cooling capacity.

16. The method of claim 15, wherein the setting of the optimal control target includes setting the optimal control target, further considering constraints for a predetermined target temperature range for a temperature of the battery.

17. The method of claim 15, wherein the optimal control target includes a flow rate of the coolant circulating in the coolant line and an introduction temperature of the coolant introduced to the battery.

18. The method of claim 12, wherein the optimal control value is a control value enabling the fluid transfer device to execute the cooling of the battery through the minimum consumption of the electric power while satisfying the optimal control target.

19. The method of claim 18,
wherein the fluid transfer device includes a coolant pump, a compressor and a fan,
wherein the fluid transfer device consumes the electric power through at least one of the coolant pump disposed at the coolant line and circulating the coolant, the compressor compressing the refrigerant and discharging the compressed refrigerant, or the fan introducing ambient air around the vehicle in the fluid transfer device, and
wherein the optimal control value is determined based on a third cost function reflecting consumed electric power of the fluid transfer device throughout a predetermined predictive range.

20. The method of claim 19, wherein the optimal control value includes at least one of a flow rate of the coolant passing through the coolant pump, a flow rate of the refrigerant discharged through the compressor, or a flow rate of the air introduced through the fan.
